(19) United States
(12) Patent Application Publication
(10) Pub. No.: US 2008/0127842 A1
(43) Pub. Date: Jun. 5, 2008

(54) Graded density filter for a printing press recirculation system

(76) Inventor: Jeffrey H. Rose, Hollywood, FL (US)

Correspondence Address: LAW PRACTICE OF SCOTT L. LAMPERT, P.A., PO BOX 813449, HOLLYWOOD, FL, 33081-3449, US

(21) Appl. No.: 11/633,186

(22) Filed: Dec. 4, 2006

(51) Int. Cl. B41L 25/00

(52) U.S. Cl. 101/148

(57) ABSTRACT

A cylindrical filter for use in a lithographic printing press recirculation system of the type that circulates fountain solution from a printing press pan, where it is applied to the printing press plate by means of a roller system, through the filter positioned in a reservoir or sump and then back to the roller system. The filter is generally cylindrical in shape and includes a hollow core extending along the central longitudinal axis of the filter, an inner surface surrounding the hollow core, an outer surface and porous filtering medium disposed between the inner surface and outer surface. The hollow core extends from a first closed end of the filter to an opposite second open end, which is removably coupled to a hose which channels the fountain solution from the printing press pan. The filtering medium comprises a graded density whereby the density at the outer surface of the filter is greater than the density at the inner surface of the filter. In use, fountain solution flows through the filtering medium from the inner surface towards the outer surface, in the direction of increasing density, resulting in contaminant particles being trapped throughout the filtering material. The fountain solution exiting the outer surface of the filtering material is then recirculated from the sump back to the printing press roller system where it is again applied to the printing press plate.

### BACKGROUND OF THE INVENTION

1. Field of the Invention

The present invention relates to filters and, more particularly, to a filter for a printing press recirculation system.

2. Description of the Related Art

Offset printing, or lithography, is a printing technique in which the image to be printed is fixed on a generally flat plate. The lithographic process is based on the principle that oil and water do not mix. Using this principle, the offset printing plate is constructed so that the image areas are ink receptive and lipophilic or water repellant and the non-image areas are hydrophilic or water receptive and ink repellant. Fountain solutions, also referred to as dampening solutions, are the agents used in lithography to wet the non-image area of the plate and repel the ink from such non-image areas.

In use, the typical process for applying fountain solution to the printing plate involves recirculating the fountain solution from a reservoir, through pipes or lines, into a pan on the press where it is applied to the plate by means of a roller system. The constant recirculation of the fountain solution after it has contacted the printing plate leads to the build up of ink, paper lint, gum residues, mold and various contaminants in the recirculation system. As the contaminants build up in the recirculation system, the fountain solution performance degrades and eventually needs to be drained from the system and the system cleaned and refilled with fresh fountain solution.

To maximize the usage of the fountain solution before having to replace it, the fountain solution is circulated through a filter positioned in the recirculation system reservoir, which is structured to remove contaminants from the fountain solution. The filters are typically comprised of a porous material having a fibrous structure, which allows the fountain solution to flow therethrough, while capturing contaminants in the filter medium. The ability of the filter to capture smaller contaminants is dependant upon the density of the filter. As the density is increased (i.e., the filter material is woven together tighter and the pores in the filter material become smaller), the filter is able to capture smaller contaminant particles, but will clog up quicker and obstruct the flow of the fountain solution. As the density is decreased (i.e., the filter material is woven together looser and the pores in the filter material become larger), the smaller contaminant particles will pass through the filter and remain in the fountain solution.

Cylindrical “inside out” filters are used in many lithographic printing press recirculation systems. With “inside out” filters, the fountain solution is channeled through a pipe or tube from the printing press pan into the hollow center of the cylindrical filter, which is positioned in the reservoir. The opposite end of the cylindrical filter is sealed so that no fountain solution can flow therethrough. Consequently, the fountain solution flows through the filter medium, entering the filter medium at the inner surface of the filter and exiting the filter medium at the outside surface of the filter.

The prior art inside out filters used in lithographic printing press recirculation systems are of uniform density throughout the filter medium. That is, the size of the pores is fairly constant throughout the filter medium, causing, for the most part, the filter to only retain particles larger than the pore size. Such uniform density inside out filters hold contaminants on the inner surface only, thereby limiting the amount of contaminants that can be captured before becoming clogged and leaving most of the filter volume, between the inner surface and the outside surface, unused.

In today's age of increased costs, increased competition and reduced margins, businesses today are constantly striving to find new ways to accomplish tasks in a more efficient and more cost effective manner. Accordingly, there is still a need in the art for a more efficient filter to remove contaminants from a lithographic printing press recirculation system. Any such system should utilize the entire filter medium, rather than just the filter's inner surface, as is the case with the prior art filters. The present invention is particularly suited to overcome those problems which remain in the art in a manner not previously known.

### SUMMARY OF THE INVENTION

The present invention is directed towards a novel, cylindrical filter for use in a lithographic printing press recirculation system of the type that circulates fountain solution from a printing press pan, where it is applied to the printing press plate by means of a roller system, through the filter positioned in a reservoir or sump and then back to the printing press pan. The filter is generally cylindrical in shape and includes a hollow core extending along the central longitudinal axis of the filter, an inner surface surrounding the hollow core, an outer surface and filtering medium disposed between the inner surface and outer surface. The hollow core extends from a first closed end of the filter to an opposite second open end. The open second end of the filter is removably coupled to a hose which channels the fountain solution from the printing press pan. The filtering medium is a porous material having a fibrous structure, which allows the fountain solution to flow therethrough. The filtering medium comprises a graded density whereby the density at the outer surface of the filter is greater than the density at the inner surface of the filter. The density of the filtering medium increases as the fountain solution traverses the filtering medium from the inner surface to the outer surface. In use, contaminant particles from the printing press plate and roller system are introduced into the fountain solution and flow from the printing press pan through a hose into the hollow core of the filter. The fountain solution then flows through the filtering medium from the inner surface towards the outer surface. As it does, smaller contaminant particles that pass through the less dense inner surface of the filtering medium are trapped throughout the filtering material as the density of the filtering material increases. The fountain solution exiting the outer surface of the filtering material is then recirculated through a hose back to the printing press roller system where it is again applied to the printing press plate.

The objects and advantages of the present invention will become more readily apparent in the description that follows.

### BRIEF DESCRIPTION OF THE DRAWINGS

For a fuller understanding of the nature of the present invention, reference should be had to the following detailed description, taken in connection with the accompanying drawings in which:

FIG. 1 is side perspective view of the graded density filter of the present invention.

FIG. 2 is a cross sectional view of the graded density filter of the present invention.

FIG. 3 is side perspective view of the printing press recirculation system using the graded density filter of the present invention.

Like reference numerals refer to like parts throughout the several views of the drawings

### DETAILED DESCRIPTION OF THE PREFERRED EMBODIMENT

Before explaining the disclosed embodiment of the present invention in detail, it is to be understood that the invention is not limited in its application to the details of the particular arrangement shown since the invention is capable of other embodiments. Also, the terminology used herein is for the purpose of description and not of limitation.

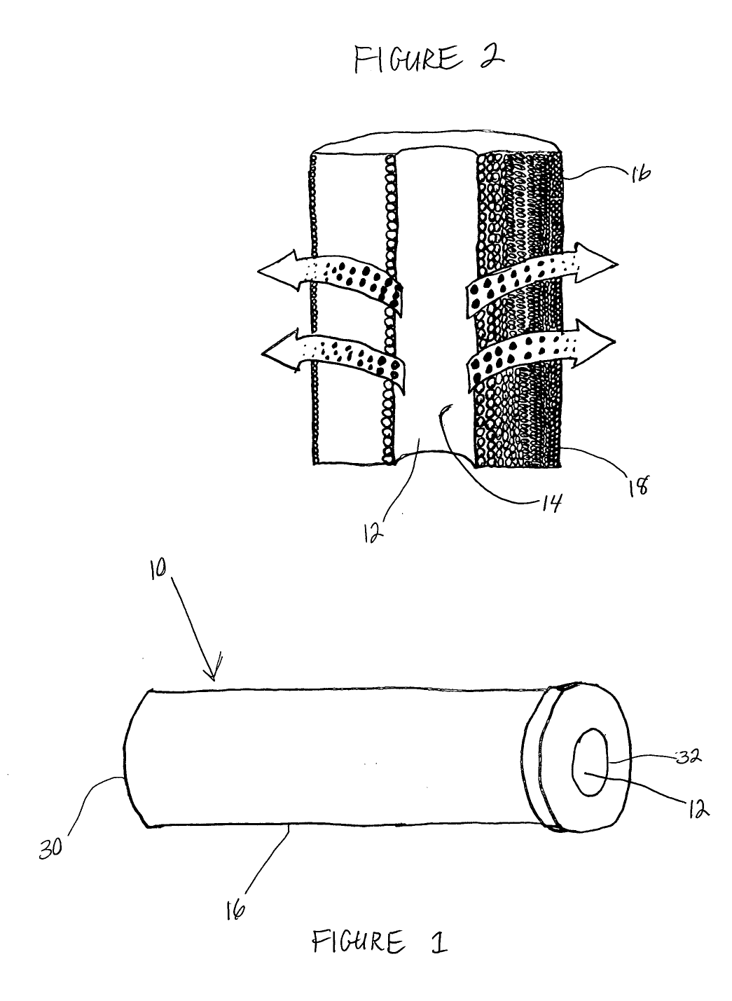

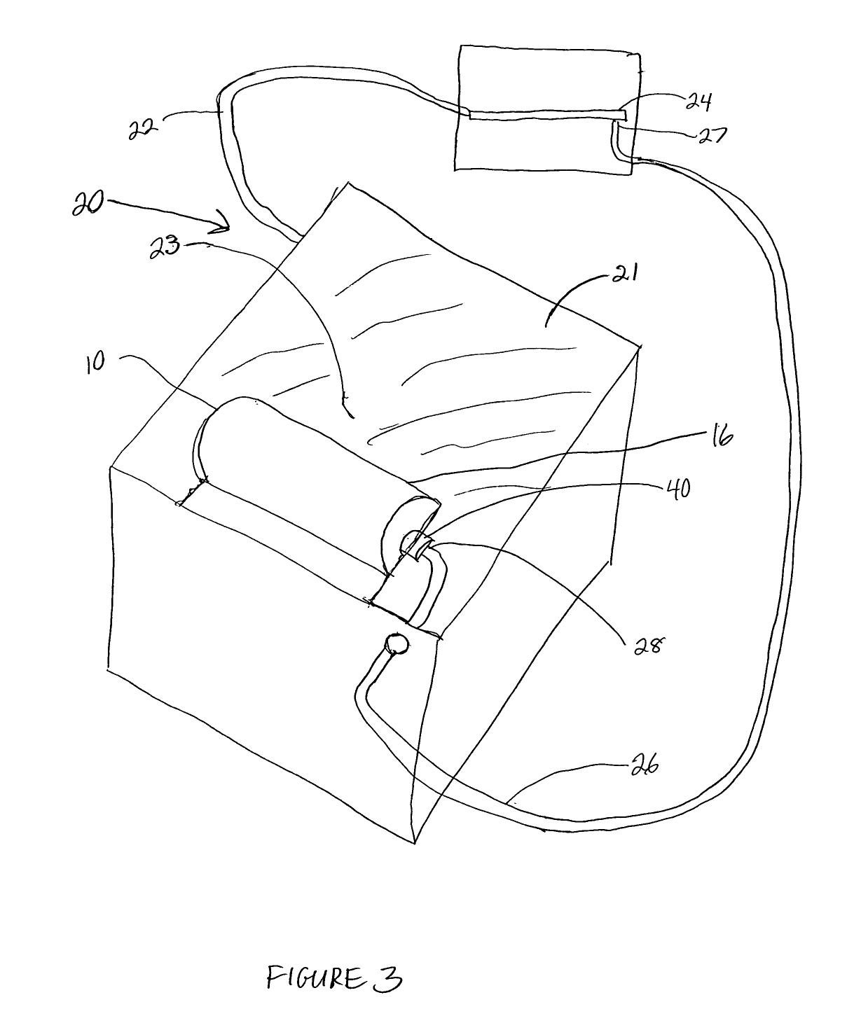

Referring now to FIGS. 1-3, the present invention is directed towards a new and improved depth filtration cylindrical filter 10. In one preferred embodiment, the filter 10 is used in a lithographic printing press recirculation system 20 of the type that circulates fountain solution 23 from a reservoir or sump 21, through a hose 22, into a pan 24, where it is applied to the printing press plate by means of a roller system (not shown). The fountain solution is then channeled from the pan back to the sump 21 through a hose 26 having a first end 27 coupled to the pan 24 and an opposite second end 28 coupled to the filter 10. The filter 10 is positioned in the sump 21 of the lithographic printing press recirculation system 20.

The Heidelberg Speedmaster Series, Komori Lithrone and Sprint Series and KBA Repida are examples of lithographic printing presses of this type. However, it should be appreciated that the filter 10 of the present invention may be used with other offset or lithographic printing presses.

The filter 10 is generally cylindrical in shape and includes a hollow core 12 extending along the central longitudinal axis of the filter 10, an inner surface 14 surrounding the hollow core 12, an outer surface 16 and filtering medium 18 disposed between the inner surface 14 and outer surface 16. The hollow core 12 extends from a first closed end 30 of the filter 10 to an opposite second open end 32 of the filter 10. The open second end 32 of the filter 10 is structured to be removably coupled to the second end 28 of hose 26. A hose barb 40 or other coupling device may be used to couple the second end 28 of hose 26 to the open end 32 of filter 10. When the second end 28 of hose 26 is coupled to the open end 32 of filter 10, the fountain solution is directed from the printing press pan 24 into the core 12 of the filter 10.

The filtering medium 18 is a porous material having a fibrous structure, which allows the fountain solution to flow therethrough. In a preferred embodiment, the filtering medium 18 is comprised of bonded polypropylene fibers. However, it should be appreciated that any other suitable fiber-like substance may, alternatively be utilized.

The polypropylene fibers are bonded into a graded pore structure so that the filtering medium 18 density at the outer surface 16 of the filter 10 is greater than the density at the inner surface 14 of the filter 10. That is, the pore size decreases as the filtering medium 18 is traversed from the inner surface 14 to the outer surface 16. In one preferred embodiment, the density of the filtering medium 18 varies from 100 microns nominal at the outer surface 16 to 200 microns nominal at the inner surface 14. However, it should be appreciated that the density of the filtering medium 18 at the outer surface 16, the inner surface 14 and therebetween may be any suitable micron ratings.

The graded density filter 10 of the present invention is structured to allow larger particles to pass through the inner surface 14 and enter the filtering medium 18. As the particles traverse the filtering medium 18 from the inner surface 14 towards the outer surface 16, the density of the filtering medium 18 increases (the pore size of the fibrous material decreases). In this manner, particles which are smaller than the inner surface 14 pore size may pass through the inner surface 14 and flow into the filtering medium 18. As particles traverse the filtering medium 18 in the direction of the outer surface 16 and the density increases, the particles encounter decreasing pore sizes resulting in particles being trapped between the inner 14 and outer 16 surfaces. Thus, the graded density filter 10 of the present invention utilizes the entire cross section or depth of the filtering medium 18 to filter out contaminant particles.

In contrast, the prior art uniform density “inside-out” filters trap contaminant particles predominantly on the inner surface only, resulting in surface loading and premature clogging of the filter. Particles that are smaller than the pore size of the uniform density prior art filters that are able to pass through the inner surface of such filters will be smaller than the pore size throughout the filtering medium and may be able to pass completely through the filtering medium.

In use, contaminant particles from the printing press plate and roller system are introduced into the fountain solution and flow from the printing press pan 24 through the hose 26 into the hollow core 12 of the filter 10. The fountain solution then flows through the filtering medium 18 from the inner surface 14 towards the outer surface 16. As it does, the density of the filtering material 18 increases, resulting in contaminant particles being trapped throughout the filtering material 18. The fountain solution exiting the outer surface 16 of the filtering material 18 is then recirculated from the sump 21 through hose 22 back to the printing press roller system where it is again applied to the printing press plate.

While the invention has been described, disclosed, illustrated and shown in various terms of certain embodiments or modifications, which it has presumed in practice, the scope of the invention is not intended to be, nor should it be deemed to be, limited thereby and such other modifications or embodiments as may be suggested by the teachings herein are particularly reserved, especially as they fall within the breadth and scope of the claims here appended.

What is claimed is:

1. A filter for use in a lithographic printing press recirculation system comprising:
a generally cylindrical shaped filtering body having a first closed end, an opposite second open end and a hollow core extending therebetween, said filtering body further including an inner surface surrounding said hollow core, an outer surface, and a filtering medium disposed between said inner surface and said outer surface, said filtering medium being of greater density at said outer surface than at said inner surface.

2. A filter as recited in claim 1, wherein said filtering medium density decreases generally uniformly from said outer surface to said inner surface.

3. A filter as recited in claim 1, wherein said filtering medium is comprised of bonded polypropylene fibers.

4. A filter as recited in claim 1, wherein said open second end is structured to be removably coupled to a hose for directing fountain solution into said hollow core.

5. A filter for use in a lithographic printing press recirculation system comprising:
a printing press having a fountain solution recirculation system structured to circulate fountain solution between a roller system and a sump; and
a generally cylindrical shaped filtering body seated in said sump, said filtering body having a first closed end, an opposite second open end and a hollow core extending therebetween, said filtering body further including an inner surface surrounding said hollow core, an outer surface, and a filtering medium disposed between said inner surface and said outer surface, said filtering medium being of greater density at said outer surface than at said inner surface.

6. A filter as recited in claim 5, wherein said fountain solution recirculation system is structured to circulate fountain solution into said hollow core of said filtering body through said second open end so that said fountain solution generally flows through said filtering medium in the direction from said inner surface towards said outer surface.

7. A filter as recited in claim 5, wherein said filtering medium density decreases generally uniformly from said outer surface to said inner surface.

8. A filter as recited in claim 5, wherein said filtering medium is comprised of bonded polypropylene fibers.

9. A filter as recited in claim 5 wherein said open second end is structured to be removably coupled to a hose for directing fountain solution from said roller system into said hollow core.

10. A filter for use in a lithographic printing press recirculation system comprising:
a printing press having a fountain solution recirculation system structured to circulate fountain solution between a roller system and a sump;
a generally cylindrical shaped filtering body seated in said sump, said filtering body having a first closed end, an opposite second open end and a hollow core extending therebetween, said filtering body further including an inner surface surrounding said hollow core, an outer surface, and a filtering medium disposed between said inner surface and said outer surface, said filtering medium having a density that decreases generally uniformly from said outer surface to said inner surface; and
wherein said fountain solution recirculation system is structured to circulate fountain solution into said hollow core of said filtering body through said second open end so that said fountain solution flows generally through said filtering medium in the direction from said inner surface towards said outer surface.

11. A filter as recited in claim 10, wherein said filtering medium is comprised of bonded polypropylene fibers.

12. A filter as recited in claim 10 wherein said open second end is structured to be removably coupled to a hose for directing fountain solution from said roller system into said hollow core.
